(19) United States
(12) Patent Application Publication
(10) Pub. No.: US 2025/0192353 A1
(43) Pub. Date: Jun. 12, 2025

(54) VENTING THERMAL EXCHANGE DEVICE FOR BATTERY PACK

(71) Applicant: Ford Global Technologies, LLC, Dearborn, MI (US)

(72) Inventors: John Peter Bilezikjian, Canton, MI (US); Derek Timothy Taylor, Waterford, MI (US); Nicholas Braeseker, Novi, MI (US)

(21) Appl. No.: 18/663,393

(22) Filed: May 14, 2024

Related U.S. Application Data
(60) Provisional application No. 63/607,888, filed on Dec. 8, 2023.

(51) Int. Cl. H01M 50/358; H01M 10/613; H01M 10/625; H01M 10/6554; H01M 10/6568; H01M 50/209

(52) U.S. Cl. CPC H01M 50/358; H01M 10/613; H01M 10/625; H01M 10/6554; H01M 10/6568; H01M 50/209

(57) ABSTRACT

A battery pack assembly includes a thermal exchange device positioned between a first cell stack on a first tier and a second cell stack on a second tier. The thermal exchange device includes at least one coolant channel that communicates a coolant to manage thermal energy in the first cell stack, the second cell stack, or both. The thermal exchange device further includes at least one vent channel that is configured to receive vent byproducts from at least one battery cell in the first cell stack, from at least one battery cell in the second cell stack, or both.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to communicating vent byproducts from battery cells with a thermal management assembly.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack assembly, including: a thermal exchange device positioned between a first cell stack on a first tier and a second cell stack on a second tier, the thermal exchange device including at least one coolant channel that communicates a coolant to manage thermal energy in the first cell stack, the second cell stack, or both, the thermal exchange device further including at least one vent channel that is configured to receive vent byproducts from at least one battery cell in the first cell stack, from at least one battery cell in the second cell stack, or both.

In some aspects, the techniques described herein relate to a battery pack assembly, wherein the first tier is a lower tier and the second tier is an upper tier.

In some aspects, the techniques described herein relate to a battery pack assembly, wherein the coolant is a liquid coolant.

In some aspects, the techniques described herein relate to a battery pack assembly, wherein the thermal exchange device is an extruded thermal exchange device.

In some aspects, the techniques described herein relate to a battery pack assembly, wherein the at least one vent channel opens downward to the first cell stack.

In some aspects, the techniques described herein relate to a battery pack assembly, further including at least one manifold secured to the thermal exchange device, the at least one manifold configured to route liquid coolant through the at least one vent channel of the thermal exchange device.

In some aspects, the techniques described herein relate to a battery pack assembly, wherein the thermal exchange device extends in a first direction past the first tier and the second tier, and in a second direction past the first tier and the second tier.

In some aspects, the techniques described herein relate to a battery pack assembly, wherein the thermal exchange device is a plate.

In some aspects, the techniques described herein relate to a battery pack assembly, further including a battery pack enclosure assembly housing the first tier of battery cells and the second tier of battery cells, wherein the thermal exchange device extends outside the battery pack enclosure assembly in a first direction past the first tier and the second tier, and in a second direction past the first tier and the second tier.

In some aspects, the techniques described herein relate to a battery pack assembly, wherein the thermal exchange device extends in the first direction and the second direction between an enclosure tray of the battery pack enclosure assembly and an enclosure cover of the battery pack enclosure assembly.

In some aspects, the techniques described herein relate to a battery pack assembly, wherein the thermal exchange device supports the second tier.

In some aspects, the techniques described herein relate to a battery pack assembly, further including an enclosure vent configured to communicate vent byproducts from the at least one vent channel to an area outside the battery pack enclosure assembly.

In some aspects, the techniques described herein relate to a battery pack venting method, including: supporting a cell stack with a thermal exchange device such that the thermal exchange device can receive vent byproducts from at least one battery cell of another cell stack, the vent byproducts received within at least one vent channel of the thermal exchange device.

In some aspects, the techniques described herein relate to a battery pack venting method, wherein the at least one vent channel opens downward.

In some aspects, the techniques described herein relate to a battery pack venting method, wherein the cell stack that is supported is an upper tier cell stack.

In some aspects, the techniques described herein relate to a battery pack venting method, wherein the at least one vent channel opens to a first horizontally facing side of the thermal exchange device, and opens to an opposite, second horizontally facing side of the thermal exchange device.

In some aspects, the techniques described herein relate to a battery pack venting method, further including circulating a liquid coolant through at least one coolant channel in the thermal exchange device.

In some aspects, the techniques described herein relate to a battery pack venting method, wherein the at least one vent channel and the at least one coolant channel each extend from a first end of the thermal exchange device to an opposite second end of the thermal exchange device.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a expanded view of the battery pack of FIG. 1.

FIG. 3 illustrates a side view of selected portions of the battery pack of FIG. 2.

FIG. 4 illustrates an end view of a venting thermal exchange plate from the battery pack of FIG. 2.

FIG. 5 illustrates a side view of a venting thermal exchange plate within a battery pack according to another exemplary embodiment of the present disclosure.

### DETAILED DESCRIPTION

This disclosure details exemplary assemblies and methods utilized to communicate vent byproducts from battery cells to an area outside the battery pack. The assemblies and methods involve communicating the vent byproducts within at least one vent channel provided by a thermal exchange assembly. Incorporating the vent channel into the thermal exchange assembly can reduce build complexity. These and other features are discussed in greater detail in the following paragraphs.

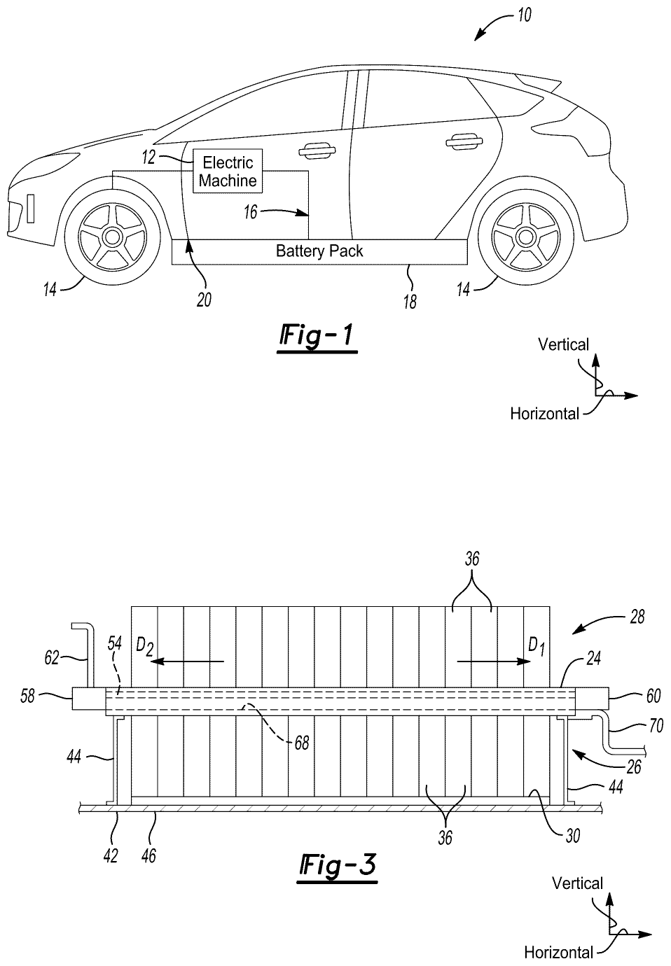

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

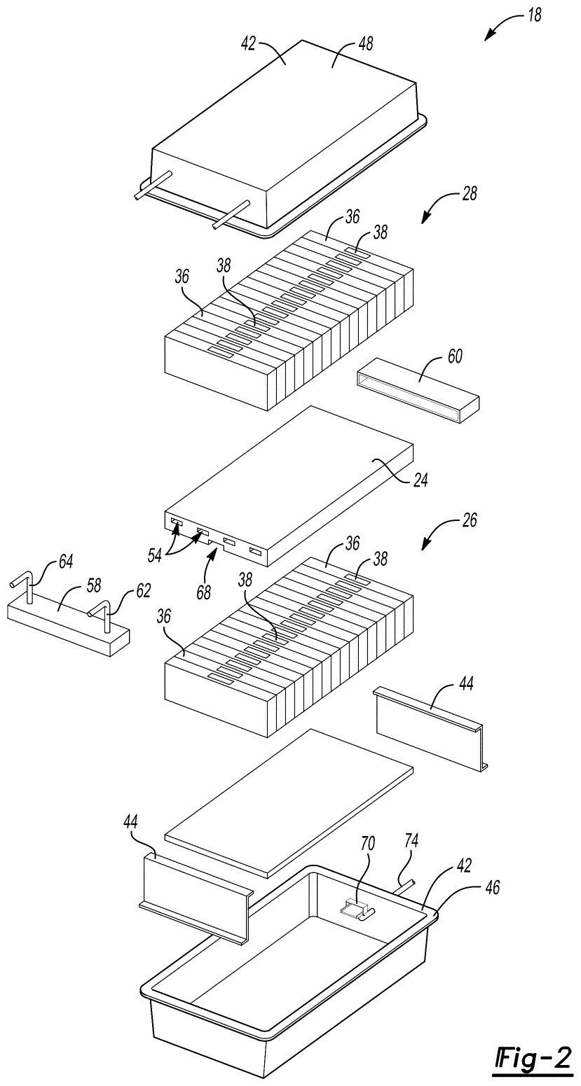

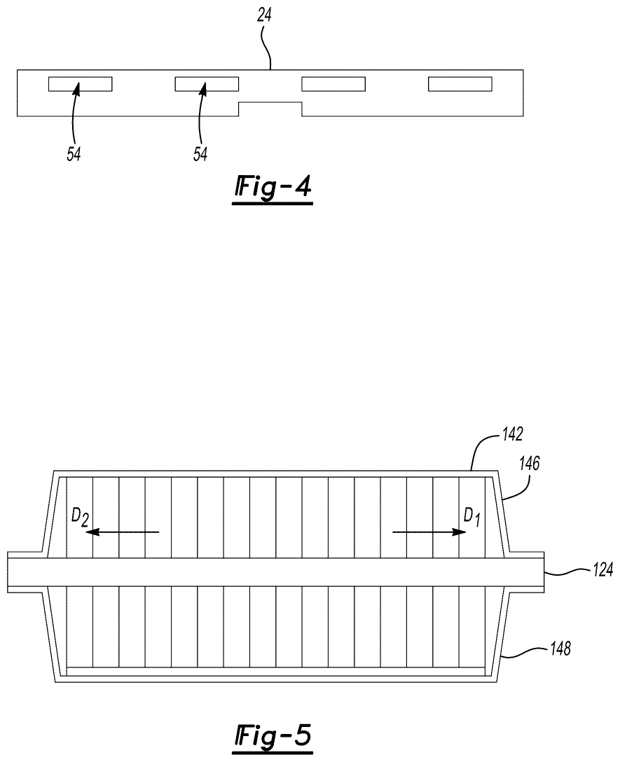

With reference to FIGS. 2-4, in an exemplary embodiment of the present disclosure, the traction battery pack 18 includes a venting thermal exchange device 24, a first cell stack 26, a second cell stack 28, and a lower thermal exchange device 30. The venting thermal exchange device 24 is positioned between the first cell stack 26 and the second cell stack 28 in this example. The second cell stack 28 is disposed upon a lower thermal exchange device 30.

The first cell stack 26 is on a first, lower tier of the battery pack 18. The second cell stack 28 is on a second, upper tier of the battery pack 18. The second cell stack 28 is vertically above the first cell stack 26. Vertical and horizontal, for purposes of this disclosure, are with reference to ground and a general orientation of the electrified vehicle 10 during operation.

The first cell stack 26 and the second cell stack 28 each include a plurality of individual battery cells 36 stacked side-by-side relative to one another along a respective cell stack axis. While the example embodiment shows one first cell stack 26 and one second cell stack 28, other examples could include more than one first cell stack 26 and more than one second cell stack 28.

In the exemplary embodiment, the battery cells 36 are lithium-ion, prismatic battery cells. However, battery cells having other geometries (cylindrical, pouch, etc.) and/or chemistries (nickel-metal hydride, lead-acid, etc.) could alternatively be utilized within the scope of this disclosure.

From time to time, pressure and thermal energy within at least one of the battery cells 36 of the battery pack 18 can increase. This can lead to the battery cell 36 discharging a flow of vent byproducts, which can include gas and debris. The vent byproducts can be discharged from the battery cell 36 through a designated cell vent 38 within a housing of the battery cell 36. The cell vent 38 can be a membrane that yields in response to increased pressure and thermal energy within the battery cell 36. The cell vent 38 can also be a ruptured area of the associated battery cell 36.

The traction battery pack 18 additionally includes a battery pack enclosure 42 and supports 44. In this example, the battery pack enclosure 42 includes an enclosure tray 46 secured to an enclosure cover 48.

The first cell stack 26, the second cell stack 28, the venting thermal exchange device 24, the lower thermal exchange device 30, and the supports 44 are held within the battery pack enclosure 42. In this example, the venting thermal exchange device 24 extends horizontally in a first direction D1 past the battery cells 36 of the first cell stack 26 and the second cell stack 28, and extends horizontally in a second direction D2 past the battery cells 36 of the first cell stack 26 and the second cell stack 28.

The venting thermal exchange device 24 extends horizontally to the supports 44, which support the venting thermal exchange device 24. The second cell stack 28 is then supported on the venting thermal exchange device 24.

The first cell stack 26, the second cell stack 28, the venting thermal exchange device 24, the lower thermal exchange device 30, and the supports 44 are contained entirely within the battery pack enclosure 42 in this example.

In another exemplary embodiment shown in FIG. 5, a venting thermal exchange device 124 extends horizontally in the first direction D1 outside an enclosure 142 between an enclosure tray 146 and an enclosure cover 148. The venting thermal exchange device 124 additionally extends horizontally in the second direction D2 outside the enclosure 142 between the enclosure tray 146 and the enclosure cover 148. The venting thermal exchange device 124 can then rest on the enclosure tray 146 and utilize the enclosure tray 146 as a support.

Referring again to FIGS. 2-4, the venting thermal exchange device 24 includes at least one coolant channel 54 that extends a length of the venting thermal exchange device 24. The at least one coolant channel 54 opens to opposing horizontal sides of the venting thermal exchange device 24 in this example. The venting thermal exchange device 124 of FIG. 5, like the device 24, includes both at least one coolant channel and at least one venting channel. At least one vent patch, such as membrane, can cover any openings from the at least one venting channel in the venting thermal exchange device 124 to areas outside the enclosure 142. The vent patch seals the openings to the at least one venting channel unless and until vent byproducts are discharged from battery cells within the enclosure 142 rupture the vent patch.

The venting thermal exchange device 24 communicates a coolant through the at least one coolant channel 54 to manage thermal energy of the battery cells 36 of the second cell stack 28. The coolant could instead or additionally manage thermal energy of the battery cells 36 of the first cell stack 26. The coolant, in this example, cools the battery cells 36. In other examples, the coolant could be used to heat the battery cells 36. The coolant, in this example, is a liquid coolant.

The battery pack 18, in this example, includes a manifold 58 and an end cap 60 secured to opposing end portions of the venting thermal exchange device 24. Mechanical fasteners, for example, could be used to secure the manifold 58 and the end cap 60 to the venting thermal exchange device 24.

A coolant inlet 62 of the manifold 58 receives a flow of coolant from outside the enclosure 42. A coolant outlet 64 of the manifold 58 communicates the flow of coolant back to a position outside the enclosure 42 after the coolant has circulated through the venting thermal exchange device 24. The manifold 58 and the end cap 60 enclose ends of the coolant channels 54 and route and redirect the coolant through the coolant channels 54.

The thermal exchange device further including at least one vent channel 68 that is separate from the coolant channels 54. In this example, the vent channel 68 opens downward through a bottom side of the venting thermal exchange device 24. The vent channel 68 also opens to opposing facing sides of the thermal exchange device 24.

The vent channel 68 is configured to receive vent byproducts from the battery cells 36 within the first cell stack 26 on the first tier. The vent byproducts are sometimes discharged from within the battery cells 36 through the respective cell vent 38. The vent channels 68 can be fluidly connected to a conduit 70 that communicates the vent byproducts from the vent channel 68 to an enclosure vent 74, which releases the vent byproducts to an area outside the battery pack enclosure 42.

The venting thermal exchange device 24 can be a cold plate. The venting thermal exchange device 24 is an extruded device in this example. In another example, the venting thermal exchange device 24 could be cast. A person having skill in this art would understand how to structurally distinguish a component that is extruded or cast from another component that is not extruded or cast. Thus, specifying that the venting thermal exchange device 24 is extruded implicates structure to the venting thermal exchange device 24, and structurally distinguishes the venting thermal exchange device 24 from other types of components that are not extruded.

Features of the disclosed examples include providing a thermal exchange device that can support an upper tier of battery cells, help to manage thermal energy levels in those battery cells, and, when required, guide vent byproducts. Incorporating all these features into the thermal exchange device can, among other things, reduce complexity.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a thermal exchange device positioned between a first cell stack on a first tier and a second cell stack on a second tier, the thermal exchange device including at least one coolant channel that communicates a coolant to manage thermal energy in the first cell stack, the second cell stack, or both, the thermal exchange device further including at least one vent channel that is configured to receive vent byproducts from at least one battery cell in the first cell stack, from at least one battery cell in the second cell stack, or both.

2. The battery pack assembly of claim 1, wherein the first tier is a lower tier and the second tier is an upper tier.

3. The battery pack assembly of claim 1, wherein the coolant is a liquid coolant.

4. The battery pack assembly of claim 1, wherein the thermal exchange device is an extruded thermal exchange device.

5. The battery pack assembly of claim 1, wherein the at least one vent channel opens downward to the first cell stack.

6. The battery pack assembly of claim 1, further comprising at least one manifold secured to the thermal exchange device, the at least one manifold configured to route liquid coolant through the at least one vent channel of the thermal exchange device.

7. The battery pack assembly of claim 1, wherein the thermal exchange device extends in a first direction past the first tier and the second tier, and in a second direction past the first tier and the second tier.

8. The battery pack assembly of claim 1, wherein the thermal exchange device is a cold plate.

9. The battery pack assembly of claim 1, further comprising a battery pack enclosure assembly housing the first tier of battery cells and the second tier of battery cells, wherein the thermal exchange device extends outside the battery pack enclosure assembly in a first direction past the first tier and the second tier, and in a second direction past the first tier and the second tier.

10. The battery pack assembly of claim 9, wherein the thermal exchange device extends in the first direction and the second direction between an enclosure tray of the battery pack enclosure assembly and an enclosure cover of the battery pack enclosure assembly.

11. The battery pack assembly of claim 9, wherein the thermal exchange device supports the second tier.

12. The battery pack assembly of claim 9, further comprising an enclosure vent configured to communicate vent byproducts from the at least one vent channel to an area outside the battery pack enclosure assembly.

13. A battery pack venting method, comprising:
supporting a cell stack with a thermal exchange device such that the thermal exchange device can receive vent byproducts from at least one battery cell of another cell stack, the vent byproducts received within at least one vent channel of the thermal exchange device.

14. The battery pack venting method of claim 13, wherein the at least one vent channel opens downward.

15. The battery pack venting method of claim 13, wherein the cell stack that is supported is an upper tier cell stack.

16. The battery pack venting method of claim 13, wherein the at least one vent channel opens to a first horizontally facing side of the thermal exchange device, and opens to an opposite, second horizontally facing side of the thermal exchange device.

17. The battery pack venting method of claim 13, further comprising circulating a liquid coolant through at least one coolant channel in the thermal exchange device.

18. The battery pack venting method of claim 17, wherein the at least one vent channel and the at least one coolant channel each extend from a first end of the thermal exchange device to an opposite second end of the thermal exchange device.
